(19) United States
(12) Patent Application Publication
(10) Pub. No.: US 2008/0074543 A1
(43) Pub. Date: Mar. 27, 2008

(54) Output processing apparatus and control method of the same

(76) Inventors: Toshio TAKADA, Tokyo (JP); Kenichi OKUNO, Kanagawa (JP)

Correspondence Address: WILLIAM S. FROMMER, Esq.;c/o FROMMER LAWRENCE & HAUG LLP, 745 Fifth Avenue, New York, NY, 10151, US

(21) Appl. No.: 11/903,684

(22) Filed: Sep. 24, 2007

(30) Foreign Application Priority Data
Sep. 27, 2006 (JP) P2006-262968

(51) Int. Cl. H04N 9/475

(52) U.S. Cl. 348/515; 348/E09.029

(57) ABSTRACT

Disclosed herein is an output processing apparatus for externally outputting a video signal having a predetermined number of audio data samples assigned to each frame in accordance with a given frame sequence, the output processing apparatus including, a storage medium adapted to store the video signal, an image processing unit adapted to read the video signal from the storage medium and apply image processing to the video signal in accordance with given image processing software, and an output control unit adapted to determine whether audio data of the video signal subjected to image processing by the image processing unit is in synchronism with the frame sequence, and if not, output the video signal after changing the number of audio data samples in each frame of the video signal subjected to image processing.

### CROSS REFERENCES TO RELATED APPLICATIONS

The present invention contains subject matter related to Japanese Patent Application JP 2006-262968 filed in the Japan Patent Office on Sep. 27, 2006, the entire contents of which being incorporated herein by reference.

### BACKGROUND OF THE INVENTION

1. Field of the Invention

The present invention relates to an output processing apparatus and a control method of the same for externally outputting a video signal having a predetermined number of audio data samples assigned to each frame in accordance with a given frame sequence.

2. Description of the Related Art

Editing machines have been common in broadcasting stations. These machines are designed to load a video signal, which contains audio and video data, into a storage medium, and process the loaded data in various manners including reuse, retouching and transmission. Such editing machines are required to write video and audio data to a storage medium in a reliable manner via a line in the broadcasting station. Further, video signal loaded may contain, depending on the communication condition of the line, noise or abnormal signal component which may result in interruption of video signal input. Therefore, editing machines is necessary to detect the validity of video and audio data loaded into a storage medium in a highly accurate manner.

Such editing machines are classified into two types; linear editing machines operable to record a video signal to a magnetic tape or other medium linearly along the time axis, and nonlinear editing machines operable to store a video signal in a storage medium physically in a piecemeal fashion (nonlinearly) although virtually linearly along the time axis. Nonlinear editing machines primarily use a hard disk as a storage medium to implement the above functionality.

Here, nonlinear editing machines can read a desired piece of data from among loaded data relatively quickly because there is no need to feed the tape as with linear editing machines. Further, nonlinear editing machines in the past perform almost all processes, including editing and processing of signal inputs and outputs, with dedicated hardware. This ensures a reliable means of avoiding data storage failures.

On the other hand, some nonlinear editing machines not only include dedicated hardware but also run image processing software on a general-purpose arithmetic processor. Such nonlinear editing machines using a general-purpose arithmetic processor have an advantage over nonlinear editing machines including dedicated hardware in that the editing method can be readily changed.

Hereinafter the term “nonlinear editing machines” refers to those machines operable to subject a signal to image processing using a general-purpose arithmetic processor and image processing software and further operable to externally transmit the signal using an input/output apparatus which is an output processing apparatus including dedicated hardware.

Incidentally, ordinary television signal has been standardized for transmission at a frame rate of 59.94 fields per second (59.94i). For audio signal in television signal formatted with a frame rate of 59.94 fields per second (59.94i), a sample count is assigned to each frame in a five-frame sequence. Here, the term “five-frame sequence” refers to an arrangement designed to achieve an audio signal sampling frequency of 48 kHz. In this arrangement, the sample count is 1602 for three of the consecutive five frames. The sample count is 1601 for the remaining two frames. This provides 1601.6 samples per frame as a whole. At the same time, the frames with a sample count of 1601 are not arranged successively (see Japanese Patent No. 2565218).

Nonlinear editing machines externally output a video signal in accordance with the above five-frame sequence. That is, these machines repeat a sequence of 1602, 1601, 1602, 1601 and 1602 samples every five frames so that the total number of audio data samples per five frames is 8008.

Hence, nonlinear editing machines need to externally output a video signal via an input/output apparatus accurately in synchronism with the sample counts as per the five-frame sequence. Here, image processing software run on an arithmetic processor manages audio data in a storage area of the hard disk based on a fixed sample count which is not compatible with that of the frames according to the five-frame sequence (e.g., 2048 samples). Alternatively, image processing software manages audio data based on 8008 samples, with five frames as a unit. Such image processing software does not manage audio data on a frame-by-frame basis. As a result, if audio data contains noise or other abnormal component, software is not capable of identifying the frame position associated with audio data containing such an abnormal component. To accurately determine the frame position associated with audio data containing such an abnormal component, therefore, it has been necessary to visually inspect the image.

Further, with such nonlinear editing machines, the processing amount in relation to image processing (e.g., data retrieval by software accessing the hard disk, application of a special effect to video data) will increase during rendering/reproducing or scrubbing. As a result of such an increase in processing amount, the arithmetic processor of a nonlinear editing machine is required to devote more of its processing capability to handling image processing, possibly making the processor unable to properly control the input/output apparatus. That is, if the processor becomes incapable of controlling the input/output apparatus, the signal from a nonlinear editing machine will become incontinuous, possibly resulting in visual or auditory noise.

It should be noted that the rendering/reproducing process is intended to apply a special effect to the video signal of video material selected by the user so as to convert the signal to a final completed material. Nonlinear editing machines display two images on the monitor, one before and another after the conversion, thus permitting the user to confirm the results. Further, application of a special effect varies in processing amount depending on the type of special effect applied. This may not make it possible to apply some types of special effects in real time.

On the other hand, scrubbing is designed to reproduce at different speeds in accordance with the timeline operation of the user. Nonlinear editing machines display an output signal on the monitor so that the user can readily retrieve a desired scene. With these machines, the video signal is stored in a hard disk in a piecemeal fashion. This may not make it possible to perform scrubbing in real time depending on the difficulty involved in data retrieval or the speed at which the signal is read from the hard disk.

Nonlinear editing machines carry out the processes described below in accordance with the load imposed on the processor by the software. These processes are intended to prevent interruption of video signal output if rendering/reproducing or scrubbing cannot be performed in real time.

As the first output process, if output is interrupted, nonlinear editing machines continuously output the signal immediately preceding the interruption. As described above, however, the software manages audio data along a time axis different from that of the frame rate. Therefore, it is difficult for nonlinear editing machines to output once again the audio data which was output in the immediately preceding frame.

Next, as the second process, nonlinear editing machines restrict image processing which cannot be carried out in real time. This makes it possible for these machines to externally output a video signal without interruption. As a result of this process, the types of editing available may be significantly limited depending on the processing capability of the processor used. To allow continuous output of a video signal which has undergone high-load image processing without interruption, therefore, a nonlinear editing machine needs to include only hardware specially designed for image processing or needs have an arithmetic processor delivering extremely high performance.

### SUMMARY OF THE INVENTION

The present invention has been accomplished in light of the above, and it is an aim of the present invention to provide an output processing apparatus and a control method of the same for externally outputting a video signal subjected to high-load image processing in software by keeping audio data of the signal accurately in synchronism with a given frame sequence.

The present invention provides, as a means of solving the above problem, an output processing apparatus operable to externally output a video signal having a predetermined number of audio data samples assigned to each of the frames. The output processing apparatus includes a storage medium adapted to store the video signal. Further, the output processing apparatus includes an image processing unit adapted to read the video signal from the storage medium and apply image processing to the video signal in accordance with given image processing software. Still further, the output processing apparatus includes an output control unit. The output control unit is adapted to determine whether audio data of the video signal subjected to image processing by the image processing unit is in synchronism with the frame sequence. The output control unit outputs the video signal after changing the number of audio data samples in each frame of the video signal subjected to image processing if the output control unit determines that audio data is not in synchronism with the frame sequence.

The present invention provides a control method of an output processing apparatus for externally outputting a video signal having a predetermined number of audio data samples assigned to each frame in accordance with a given frame sequence. The control method reads the video signal from the storage medium included in the output processing apparatus in accordance with given image processing software and applies image processing to video data of the video signal. Further, the control method determines whether audio data of the video signal subjected to the image processing is in synchronism with the frame sequence. The control method outputs the video signal after changing the number of samples in each frame of audio data of the video signal in accordance with the determination result.

The present invention determines whether audio data of a video signal subjected to image processing by image processing software is in synchronism with a given frame sequence. Further, the present invention outputs a video signal after changing the number of samples in each frame of audio data of the video signal in accordance with the determination result. This makes it possible to externally output a video signal accurately in synchronism with a frame sequence even if the video signal has been subjected to a high-load special effect.

### BRIEF DESCRIPTION OF THE DRAWINGS

FIG. 1 is a block diagram illustrating the configuration of a nonlinear editing machine;

FIG. 2 is a block diagram illustrating the configuration of an input/output processing apparatus;

FIG. 3A is a view schematically illustrating the input processing of a video signal in the past, and FIG. 3B is a view schematically illustrating the input processing of a video signal according to the present embodiment;

FIG. 4 is a view schematically illustrating the rearrangement of sample data based on a five-frame sequence; and

FIG. 5 is a view schematically illustrating the process adapted to output audio data based on a stop signal.

### DETAILED DESCRIPTION OF THE PREFERRED EMBODIMENT

The preferred embodiment of the present invention will be described in detail below with reference to the accompanying drawings.

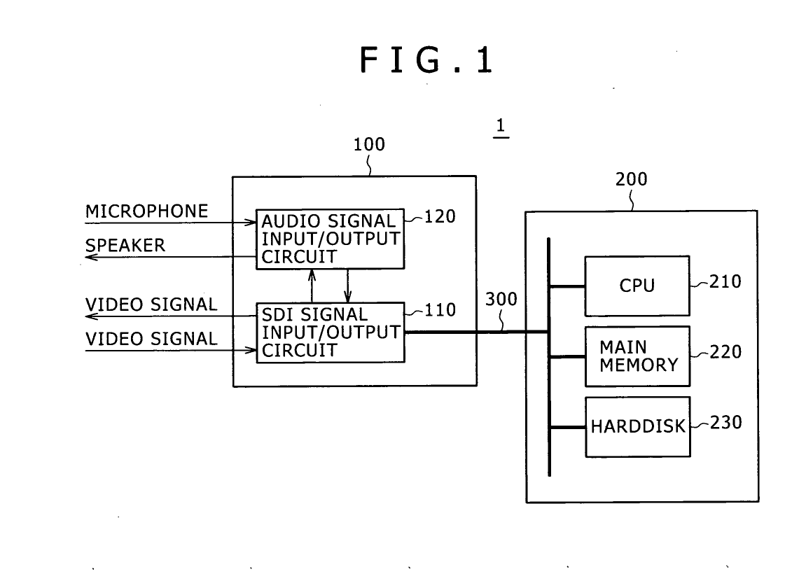

As illustrated in FIG. 1, a nonlinear editing machine 1 according to the present embodiment includes an input/output processing apparatus 100, a computer 200 and a bus 300 adapted to connect the input/output processing apparatus 100 and the computer 200.

The input/output processing apparatus 100 includes an SDI (Serial Digital Interface) signal input/output circuit 110 and an audio signal input/output circuit 120. Here, the SDI standard is designed for transmission of serialized video signal made up of video and audio data. It should be noted that although video signal is transmitted according to the SDI standard in the present embodiment, the present invention is not limited to this standard. A signal compliant with any standard may be used so long as video and audio data of the signal are in synchronism with each other.

The SDI signal input/output circuit 110 separates an externally input video signal, compliant with the SDI standard, into video and audio data. Then, the SDI signal input/output circuit 110 supplies the two pieces of data to the computer 200 via the bus 300. The SDI signal input/output circuit 110 converts video and audio data supplied from the computer 200 via the bus 300 into a video signal and outputs it externally.

The audio signal input/output circuit 120 combines an audio signal from a microphone and the like with another audio signal from the SDI signal input/output circuit 110. Then, the audio signal input/output circuit 120 outputs the resultant signal to a speaker and the like.

The computer 200 includes a CPU 210, a main memory 220 and a hard disk 230. In the computer 200, the CPU 210 stores, in the hard disk 230, video and audio data supplied from the input/output processing apparatus 100 via the bus 300. The CPU 210 reads video and audio data, which will be used for editing such as rendering/reproducing or scrubbing, from the hard disk 230 into the main memory 220. The CPU 210 does so in accordance with given editing software. Then, the CPU 210 edits the data read into the main memory 220 and supplies the resultant data to the SDI signal input/output circuit 110 via the bus 300.

The nonlinear editing machine 1 separates an externally input video signal compliant with the SDI standard into video and audio data. Then, the nonlinear editing machine 1 stores the data in the hard disk 230 of the computer 200. In the nonlinear editing machine 1, the main CPU 210 reads data to be edited from the hard disk 230 and edits the data. Then, the main CPU 210 externally outputs the edited data via the bus 300 and the input/output processing apparatus 100. Here, a delay may occur during the supply of data from the computer 200 to the input/output processing apparatus 100 via the bus 300 when editing is performed by the computer 200. In this case, the nonlinear editing machine 1 is unable to externally output a video signal from the input/output processing apparatus 100 without interruption. Such a delay occurs from one of two main causes. One of them is a significant change in time required to retrieve data to be edited from the hard disk 230. This change may occur depending on the data management status on the hard disk 230. Another possible cause is a significant change in time required to edit data. This change may occur depending on the type of data to be edited.

For this reason, the present embodiment will be described below with particular focus on the configuration and operation of the input/output processing apparatus 100 operable to ease the impact of such a delay.

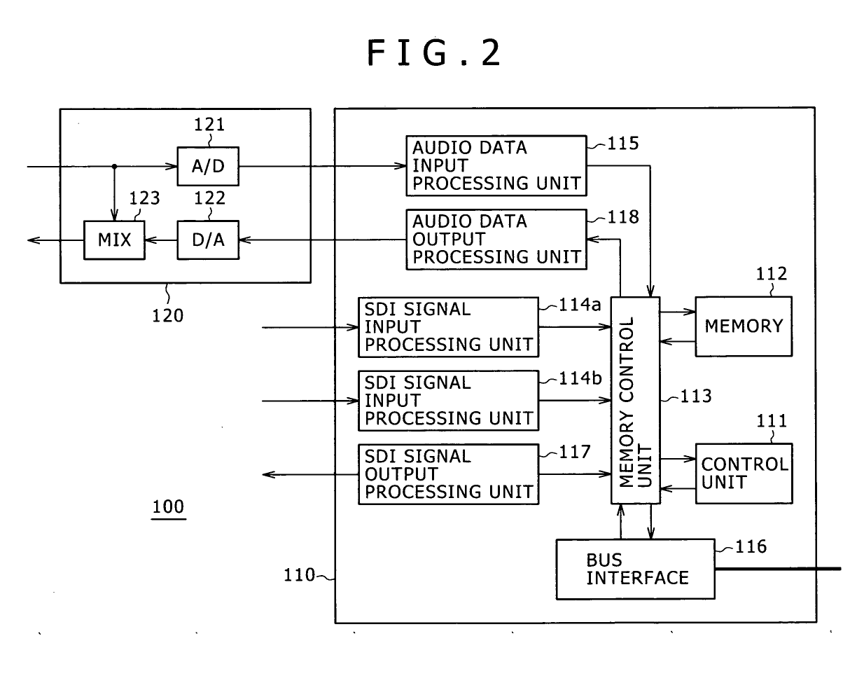

A description will be made first of the configuration and operation of the SDI signal input/output circuit 110 among the circuits included in the input/output processing apparatus 100. As illustrated in FIG. 2, the SDI signal input/output circuit 110 includes a control unit 111, a memory 112, a memory control unit 113, an SDI signal input processing unit 114, an audio data input processing unit 115, a bus interface 116, an SDI signal output processing unit 117 and an audio data output processing unit 118.

The control unit 111 controls the operation of all the processing units included in the SDI signal input/output circuit 110 in accordance with a control signal from the computer 100.

The memory 112 writes or reads data to or from its own storage area in accordance with a control instruction from the memory controller 113. More specifically, the memory 112 stores video and audio data, metadata relating to SDI signal and control signal from the computer 200.

The SDI signal input processing unit 114 receives a video signal compliant with the SDI standard from an output source. The SDI signal input processing unit 114 separates an input video signal into video and audio data and metadata based on the SDI standard. Further, the SDI signal input processing unit 114 supplies each of the separated pieces of data to the memory 112 via the memory control unit 113.

It should be noted that, in the present embodiment, the input/output processing apparatus 100 has two SDI signal input processing units 114a and 114b. These units each receive a video signal from an output source different from each other. In the present embodiment, the two SDI signal input processing units 114a and 114b are collectively termed the SDI signal input processing unit 114 for reasons of convenience, and the operation of each unit will be described.

The audio data input processing unit 115 receives audio data from the audio signal input/output circuit 120. The audio data input processing unit 115 supplies the received audio data to the memory 112 via the memory control unit 113.

The bus interface 116 supplies video and audio data stored in the memory 112 to the computer 200 in accordance with a control instruction from the memory control unit 113. Further, the bus interface 116 stores video and audio data, supplied from the computer 200 via the bus 300, in the memory 112 in accordance with a control instruction from the memory control unit 113.

The SDI signal output processing unit 117 reads video and audio data from the memory 112 in accordance with a control instruction from the memory control unit 113. The SDI signal output processing unit 117 converts the read data into a video signal compliant with the SDI standard and outputs the signal externally.

The audio data output processing unit 118 reads audio data from the memory 112 in accordance with a control instruction from the memory control unit 113. Then, the audio data output processing unit 118 supplies the read data to the audio signal input/output circuit 120 in synchronism with the video signal compliant with the SDI standard.

A description will be made next of the configuration and operation of the audio signal input/output circuit 120 among the circuits included in the input/output processing apparatus 100. The audio signal input/output circuit 120 includes an analog/digital conversion unit 121, a digital/analog conversion unit 122 and an analog signal combining unit 123.

The analog/digital conversion unit 121 converts audio signal in analog form from a microphone and the like into audio data. The analog/digital conversion unit 121 supplies the converted audio data to the input/output processing apparatus 100.

The digital/analog conversion unit 122 converts audio data from the input/output processing apparatus 100 into an audio signal in analog form. The digital/analog conversion unit 122 supplies the converted audio signal to the analog signal combining unit 123.

The analog signal combining unit 123 combines an audio signal from a microphone and the like with another audio signal from the digital/analog conversion unit 122. The analog signal combining unit 123 outputs the combined audio signal to the speaker and the like.

A description will be made next about input processing adapted to supply a video signal, which is fed from an external device to the SDI signal input/output circuit 110, to the computer 200.

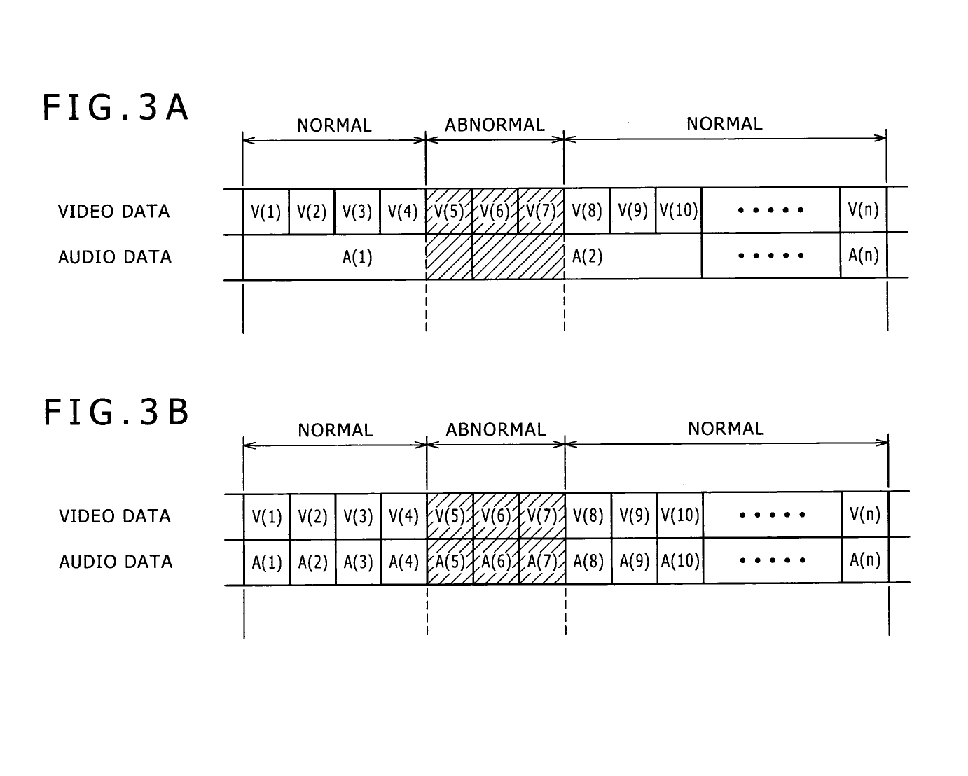

Input processing in the past will be described first. FIG. 3A schematically illustrates input processing performed by an SDI signal input/output circuit in the pasts.

Here, video data of a video signal is typically standardized in the SDI and other standards so that the frame rate thereof is 59.94 fields per second (59.94i). For audio data, on the other hand, a sample count is assigned to each frame in a five-frame sequence.

Therefore, the input processing in the past supplies audio data in asynchronism with video signal frames. As illustrated in FIG. 3A, for example, an SDI signal input circuit in the past supplies five frames of audio data to a computer as unit data.

When supplied with video and audio data as a result of the input processing in the past, the computer manages video data on a frame-by-frame basis. On the other hand, the computer manages audio data based on the number of samples per five frames as a data unit.

Here, we assume, for example, that at least either video or audio data of a video signal fed to the SDI signal input/output circuit contains noise or other abnormal data component during an interval between video data V(5) and V(7). In this case, the computer does not manage audio data on a frame-by-frame basis. Therefore, the computer is unable to accurately identify the portion of the data containing the aforementioned abnormal data component from audio data A(1) and A(2).

In contrast to the input processing in the past described above, the computer 200 in the present embodiment stores both video and audio data in the hard disk 230 on a frame-by-frame basis and manages them as such as illustrated in FIG. 3B. To implement this type of data management on the computer 200, the SDI signal input/output circuit 110 controls video signal input from an external device as described below, after which the circuit 110 supplies video and audio data to the computer 200.

That is, the SDI signal input processing unit 114 of the SDI signal input/output circuit 110 detects the number of audio data samples in each frame when separating the video signal into video and audio data. Based on the detection result, the SDI signal input processing unit 114 supplies audio data to the memory 112 on a frame-by-frame basis.

Further, the SDI signal input processing unit 114 detects whether the frame, vertical and horizontal synchronizing signals of an externally input video signal are locked. Further, the SDI signal input processing unit 114 detects the checksum of video and audio data.

On the other hand, the audio data input processing unit 115 similarly detects the number of audio data samples in each frame and the checksum of each frame in synchronism with a video signal fed to the SDI signal input processing unit 114.

Then, the SDI signal input processing unit 114 terminates the process adapted to supply video and audio data to the memory 112 based on information about reference frame stored in a memory provided therein. At the end of the process, the SDI signal input processing unit 114 determines the validity of the data stored in the memory 112. The SDI signal input processing unit 114 does so based on the number of audio data samples in each frame and the checksum detection result for each frame. The SDI signal input processing unit 114 supplies the determination result to the memory control unit 113. Similarly, the audio data input processing unit 115 determines the validity and supplies the determination result to the memory control unit 113 at the end of the process.

The memory control unit 113 temporarily stores, in a cash memory provided therein, the determination results regarding the data validity from the SDI signal input processing unit 114 and the audio data input processing unit 115. The memory control unit 113 also supplies the determination results to the control unit 111.

The control unit 111 checks the details of the determination results regarding the data validity from the memory control unit 113. Then, the control unit 111 supplies a control signal to the memory control unit 113 so that the determination results will be supplied to the computer 200. The memory control unit 113 supplies the determination results regarding the data validity to the computer 200.

As described above, the SDI signal input/output circuit 110 supplies, to the computer 200, the determination results regarding the validity of the input video signal for both video and audio data.

Thus, the computer 200 stores video and audio data from the input/output processing apparatus 100 in the hard disk 230. This makes it possible for the computer 200 to check the data validity on a frame-by-frame basis, based on the determination results regarding the validity of the input video signal from the input/output processing apparatus 100. As a result, the computer 200 is capable of the process described below.

As illustrated in FIG. 3B, the computer 200 can manage audio data in the hard disk 230 in such a manner that audio data is associated with frames which are in synchronism with video data. Thus, if noise or other abnormal data component is contained in video and audio data during a frame interval from the video signals V(5) to V(7), audio data A(5) to A(7) which are associated with frames can be readily and quickly retrieved from the hard disk 230.

As described above, with the nonlinear editing machine 1, the input/output processing apparatus 100 supplies, to the computer 200, audio data which contains the number of audio data samples associated with each of the frames as a data unit. This allows for the computer 200 of the nonlinear editing machine 1 to process video and audio data in synchronism with each other. Further, the validity of video and audio data can be determined on a frame-by-frame basis. This permits proper operation according to the application.

That is, the nonlinear editing machine 1 can, for example, inspect the reliability of a broadcast circuit of an output source based on the determination results regarding the data validity. Further, the nonlinear editing machine 1 can rearrange data containing an abnormal signal component with other data on a frame-by-frame basis according to the inspection results. Alternatively, the nonlinear editing machine 1 can create new data by interpolating data containing an abnormal signal component with data before and after the data in question on a frame-by-frame basis.

A description will be made next about the process adapted to output data edited by the computer 200 from the SDI signal input/output circuit 110.

In the computer 200, the CPU 210 reads the data to be edited from the hard disk 230 into the main memory 220 for editing. Then, the CPU 210 supplies the edited data to the input/output processing apparatus 100 via the bus 300.

As described above, the computer 200 manages video and audio data on a frame-by-frame basis in the storage area of the hard disk 230. In the input/output processing apparatus 100, therefore, the memory 112 of the SDI signal input/output circuit 110 stores both video and audio data, edited by the computer 200, on a frame-by-frame basis.

Further, the computer 200 supplies an output control instruction together with edited video and audio data to the input/output processing apparatus 100 via the bus 300. This output control instruction is intended to instruct that a video signal for the video and audio data be output externally. In the input/output processing apparatus 100, therefore, the control unit 111 of the SDI signal input/output circuit 110 outputs the edited data from the memory 112 to an external device via the SDI signal output processing unit 117. The control unit 111 does so in accordance with an output control signal from the computer 200.

As described above, the computer 200 edits data to be edited and supplies the edited data to the input/output processing apparatus 100. Here, the computer 200 may fail to supply data to the input/output processing apparatus 100 in accordance with a frame sequence compliant with the SDI standard. Therefore, the computer 200 determines whether it can supply data to the input/output processing apparatus 100 based on a frame sequence. If the computer 200 determines that it will fall out of synchronism, it will supply an output control instruction to this effect to the control unit 111 of the SDI signal input/output circuit 110.

In the SDI signal input/output circuit 110, the control unit 111 causes the SDI signal output processing unit 117 to set an audio data sample count associated with each frame as described below in accordance with an output control signal from the computer 200.

In the present embodiment, it is assumed that the nonlinear editing machine 1 manages audio data in a five-frame sequence based on the SDI standard. That is, when outputting a video signal, the nonlinear editing machine 1 repeats, based on a five-frame sequence, a sequence of 1602, 1601, 1602, 1601 and 1602 samples every five frames so that the total number of audio signal samples per five frames is 8008.

Therefore, if 1602 audio data samples are supplied from the computer 200 when the SDI signal output processing unit 117 should output 1601 audio data samples in accordance with a five-frame sequence, the SDI signal output processing unit 117 will be unable to output data samples due to an excess of one sample. Conversely to this, if 1601 audio data samples are supplied from the computer 200 when the SDI signal output processing unit 117 should output 1602 audio data samples in accordance with a five-frame sequence, the SDI signal output processing unit 117 will be unable to output data samples due to a shortage of one sample.

Therefore, if the number of audio data samples supplied from the computer 200 is one more than the number of samples to be output from the input/output processing apparatus 100, the SDI signal output processing unit 117 outputs the required number of samples by assigning the last one sample of the supplied audio data (hereinafter referred to as excess data sample) to the first position of the frame to be output next. Conversely to this, if the number of audio data samples supplied from the computer 200 is one less than the number of samples to be output from the input/output processing apparatus 100, the SDI signal output processing unit 117 outputs the last one sample of the supplied audio data twice in a row.

As described above, even if the computer 200 supplies audio data which is in asynchronism with a five-frame sequence, the SDI signal output processing unit 117 is capable of externally outputting a video signal without any excess or shortage of audio data samples through the above sample data rearrangement.

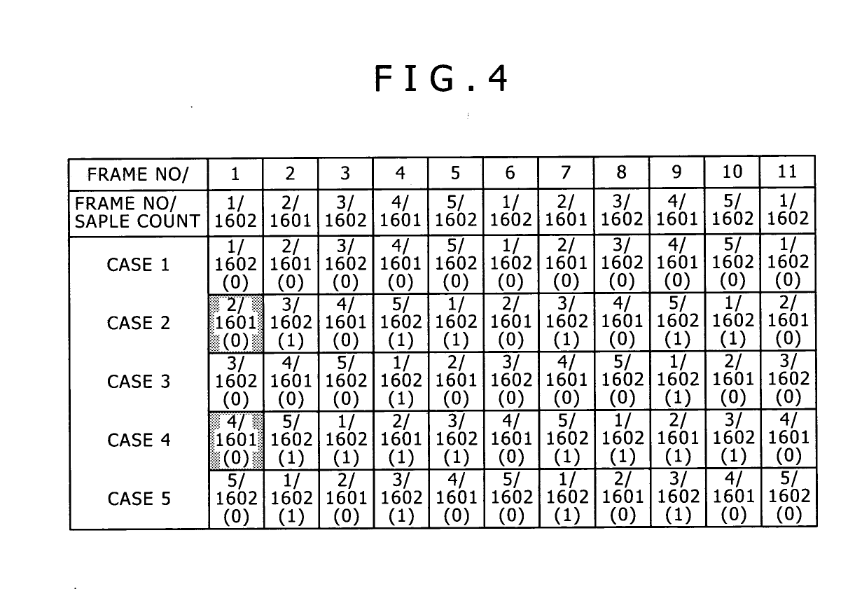

More specifically, the SDI signal output processing unit 117 carries out sample data rearrangement as illustrated in FIG. 4. That is, FIG. 4 schematically illustrates a deviation between an audio data frame sequence supplied from the computer 200 to the input/output processing apparatus 100 and a frame sequence of audio signal output from the input/output processing apparatus 100. Here, there are five possible cases (cases 1 to 5) of a deviation in frame sequence between the computer 200 and the input/output processing apparatus 100.

First, the topmost row in FIG. 4 shows the number of audio data samples per frame to be output by the SDI signal output processing unit 117.

Case 1 shows the number of audio data samples output from the computer 200 to the bus 300 when there is no deviation from the frame sequence of the SDI signal output processing unit 117. In this case, the SDI signal output processing unit 117 does not need to perform sample data rearrangement.

Case 2 shows the number of audio data samples output from the computer 200 to the bus 300 if the frame number differs by one from that of the frame sequence of the SDI signal output processing unit 117. In this case, there is a shortage of one data sample in the first frame. Therefore, the SDI signal output processing unit 117 outputs the last data sample in this frame twice in a row. From here onward, the SDI signal output processing unit 117 carries out sample data rearrangement in accordance with the number of excess data samples (number in a bracket in the figure) in each frame number. This makes it possible for the SDI signal output processing unit 117 to externally output a video signal without any excess or shortage of audio data samples.

Case 3 shows the number of audio data samples output from the computer 200 to the bus 300 if the frame number differs by two from that of the frame sequence of the SDI signal output processing unit 117. In this case, the SDI signal output processing unit 117 carries out sample data rearrangement in accordance with the number of excess data samples (number in a bracket in the figure) in each frame number. This makes it possible for the SDI signal output processing unit 117 to externally output a video signal without any excess or shortage of audio data samples.

Case 4 shows the number of audio data samples output from the computer 200 to the bus 300 if the frame number differs by three from that of the frame sequence of the SDI signal output processing unit 117. In this case, there is a shortage of data sample in the first frame. Therefore, the SDI signal output processing unit 117 outputs the last data sample in this frame twice in a row. From here onward, the SDI signal output processing unit 117 carries out sample data rearrangement in accordance with the number of excess data samples (number in a bracket in the figure) in each frame number. This makes it possible for the SDI signal output processing unit 117 to externally output a video signal without any excess or shortage of audio data samples.

Case 5 shows the number of audio data samples output from the computer 200 to the bus 300 if the frame number differs by four from that of the frame sequence of the SDI signal output processing unit 117. In this case, the SDI signal output processing unit 117 carries out sample data rearrangement in accordance with the number of excess data samples (number in a bracket in the figure) in each frame number. This makes it possible for the SDI signal output processing unit 117 to externally output a video signal without any excess or shortage of audio data samples.

That is, the nonlinear editing machine 1 according to the present embodiment determines whether it can supply data edited by image processing software to the input/output processing apparatus 100 in accordance with a five-frame sequence. Based on the determination results, the nonlinear editing machine 1 externally outputs data after changing the number of edited audio data samples on a frame-by-frame basis. This makes it possible to externally output a video signal precisely compliant with a five-frame sequence, for example, if the signal has been subjected to a high-load special effect.

Depending on the type of editing performed by the computer, the nonlinear editing machine 1 may become unable to supply edited data to the SDI signal input/output circuit 110 in real time while at the same time editing data, in the event of an excessive increase in load imposed on the CPU 210. That is, the nonlinear editing machine 1 may fail to supply data edited by the computer 200 to the input/output processing apparatus 100 without interruption.

In such a case, a nonlinear editing machine in the past continuously outputs video data immediately preceding interruption of data supply from the computer 200 to the input/output processing apparatus 100. The nonlinear editing machine in the past continues this output until supply of video data from the computer 200 is restored to normal. Further, the nonlinear editing machine in the past mutes the sound for a period of time during which edited data is not supplied from the computer to the input/output processing apparatus. The nonlinear editing machine in the past may suddenly undergo an abrupt transition from a normal condition in which it outputs an audio signal at a normal amplitude level to a muted condition. In such a case, the nonlinear editing machine in the past outputs audio data containing noise. Further, the nonlinear editing machine in the past reduces the load on the computer to reduce auditory noise, thus ensuring non-stop supply of edited data.

To reduce such noise, therefore, the nonlinear editing machine 1 according to the present embodiment performs the processes described below using the SDI signal input/output circuit 110.

That is, the control unit 111 of the SDI signal input/output circuit 110 determines, based on an output control instruction from the computer 200, whether a next frame of data to be output will be supplied from the computer 200. Then, the SDI signal input/output circuit 110 supplies the determination result to the SDI signal output processing unit 117. Here, the CPU 210 of the computer 200 determines whether it can continuously supply edited data to the input/output processing apparatus 100. It not, the CPU 210 will supply an output control instruction including a stop signal to the input/output processing apparatus 100.

If the SDI signal output processing unit 117 determines, based on the determination result from the control unit 111, that data supply from the computer 200 will be interrupted, the SDI signal output processing unit 117 continuously outputs video data immediately preceding interruption of data supply. The SDI signal output processing unit 117 continues this output until data supply from the computer 200 is initiated, as with an editing machine in the past.

Further, the SDI signal output processing unit 117 processes audio data as described below. That is, if the SDI signal output processing unit 117 determines, based on a stop signal from the control unit 111, that data supply from the computer 200 will be interrupted, it gradually reduces the level of audio signal immediately preceding the interruption before outputting the signal externally. The SDI signal output processing unit 117 does so to reduce noise resulting from a transition to a muted condition. The SDI signal output processing unit 117 does so in such a manner that the last sample is muted. The SDI signal output processing unit 117 continues to externally output mute audio data until data supply from the computer 200 stops. Then, as data supply from the computer 200 is initiated, the SDI signal output processing unit 117 gradually increases the amplitude level of audio signal in the first frame from a muted condition before outputting the signal externally. The SDI signal output processing unit 117 does so in such a manner that the last sample in the frame will rise to a normal amplitude level.

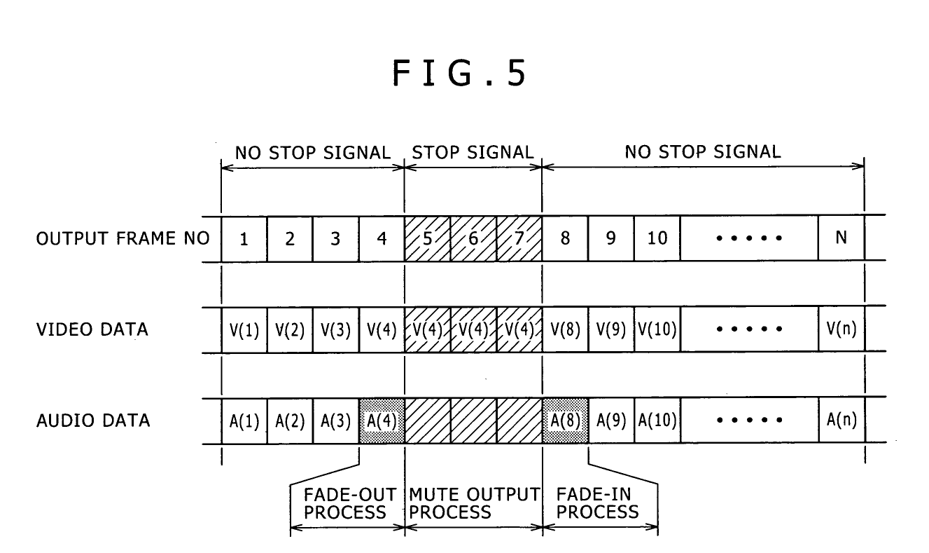

FIG. 5 schematically illustrates the operation of the SDI signal output processing unit 117 if no edited data is supplied from the computer 200 to the input/output processing apparatus 100 during a frame interval from output frame No. 5 to output frame No. 7.

As for video data, the SDI signal output processing unit 117 continues to output video data V(4) immediately preceding the interruption during a frame interval from output frame No. 5 to output frame No. 7. As for audio data, the SDI signal output processing unit 117 outputs an audio signal A(4) after gradually reducing the amplitude level thereof down to a muted condition (fade-out process). Then, the SDI signal output processing unit 117 outputs muted audio data during a frame interval from output frame No. 5 to output frame No. 7. Further, the SDI signal output processing unit 117 outputs an audio signal A(8) in output frame No. 8 after gradually increasing the signal level thereof from a muted condition to a normal amplitude level during that interval (fade-in process).

As described above, the SDI signal output processing unit 117 performs fade-out and fade-in processes respectively on one frame of audio data immediately before and after the interruption of data supply from the computer 200. It should be noted that the SDI signal output processing unit 117 may perform the fade-out and fade-in processes respectively on a plurality of frames of audio data immediately before and after the interruption of data supply from the computer 200.

Thus, the SDI signal input/output circuit 110 can reduce visual and auditory noise resulting from interruption of data supply from the computer 200 without changing the types of processes performed by the computer 200 even if data is not continuously supplied from the computer 200.

It should be noted that the audio data input processing unit 115 also supplies audio data to the audio signal input/output circuit 120 after changing the amplitude level of audio signal in accordance with an output control instruction from the control unit 111, as with the SDI signal output processing unit 117.

As described above, the nonlinear editing machine 1 according to the present embodiment provides an editing environment free from visual and auditory discomfort caused to the user engaged in editing.

It should be noted that the present invention is not limited to the aforementioned embodiment, but may be modified in various manners within the scope of the present invention.

What is claimed is:

1. An output processing apparatus for externally outputting a video signal having a predetermined number of audio data samples assigned to each frame in accordance with a given frame sequence, the output processing apparatus comprising:
a storage medium adapted to store the video signal;
an image processing unit adapted to read the video signal from the storage medium and apply image processing to the video signal in accordance with given image processing software; and
an output control unit adapted to determine whether audio data of the video signal subjected to image processing by the image processing unit is in synchronism with the frame sequence, and if not, output the video signal after changing the number of audio data samples in each frame of the video signal subjected to image processing.

2. The output processing apparatus of claim 1 further comprising an input control unit adapted to detect the number of audio data samples in each frame of the externally input video signal and further adapted to supply, based on the detection result, the input video signal to the image processing unit, wherein
the image processing unit stores audio data of the input video signal on a frame-by-frame basis based on the detection result obtained by the input control unit.

3. The output processing apparatus of claim 1, wherein
the image processing unit determines whether it can continuously supply a video signal subjected to the image processing to the output control unit, and if not, supplies a stop signal to the output control unit, and wherein
the output control unit reduces the amplitude of audio data of the video signal down to a muted condition after receiving the stop signal from the image processing unit, and increases the amplitude of audio data of the video signal from a muted condition to a normal level when the image processing unit no longer supplies the stop signal.

4. A control method of an output processing apparatus for externally outputting a video signal having a predetermined number of audio data samples assigned to each frame in accordance with a given frame sequence, the control method comprising the steps of:
reading the video signal from a storage medium included in the output processing apparatus and applying image processing to the video signal in accordance with given image processing software; and
determining whether audio data of the video signal subjected to image processing by the image processing unit is in synchronism with the frame sequence, and if not, outputting the video signal after changing the number of audio data samples in each frame of the video signal subjected to image processing.

5. The control method of claim 4 further comprising an input control step of detecting the number of audio data samples in each frame of the externally input video signal and applying, based on the detection result, the image processing to the externally input video signal, wherein
audio data of the input video signal is stored in the storage medium on a frame-by-frame basis based on the detection result obtained by the input control step.

6. The control method of claim 4 further comprising an output control step of determining whether a video signal subjected to the image processing can be continuously output, and if not, supplying a stop signal, and wherein
the output control step reduces the amplitude of audio data of the video signal down to a muted condition after receiving the stop signal, and increases the amplitude of audio data of the video signal from a muted condition to a normal level when the stop signal is no longer supplied.
